(19) United States
(12) Patent Application Publication
(10) Pub. No.: US 2021/0359928 A1
(43) Pub. Date: Nov. 18, 2021

(54) MODEL FOR TEMPLATE BASED TESTING IN SDN NETWORKS

(71) Applicant: NOKIA SOLUTIONS AND NETWORKS OY, Espoo, FL (US)

(72) Inventors: Richard CUNDALL, Cres (CA); Jonathan WILSON, Almonte (CA); Christopher MCINTOSH, Kanata (CA)

(21) Appl. No.: 16/875,556

(22) Filed: May 15, 2020

(51) Int. Cl. H04L 12/26; H04L 12/24

(52) U.S. Cl. CPC H04L 43/50; H04L 41/145

(57) ABSTRACT

A method for testing a software defined network (SDN) including a plurality of equipment, including: selecting a test case, wherein the test case includes a test step to be performed on an equipment of the SDN and wherein the test step includes a template logical indicator and a variable file logical indicator; executing the test case including obtaining a network definition for the SDN, obtaining a template for the equipment in the SDN to be tested indicated by the template logical indicator at run time, populating variable values in the obtained template using variable values from a variable file indicated by the variable file logical indicator at run time, and executing a first test step indicated in the template using the populated variable values.

### TECHNICAL FIELD

Various exemplary embodiments disclosed herein relate generally to a system and method for template based testing in software defined networks (SDN).

### BACKGROUND

Software-defined networking (SDN) technology is an approach to network management that enables dynamic, programmatically efficient network configuration in order to improve network performance and monitoring. SDN is meant to address the fact that the static architecture of traditional networks is decentralized and complex while current networks require more flexibility and easy troubleshooting. SDN attempts to centralize network intelligence in one or a few network component(s) by disassociating the forwarding process of network packets (data plane) from the routing process (control plane). The control plane includes one or more controllers where the whole knowledge of the network is kept.

Because SDN architectures decouple network control and forwarding functions, the SDN enables the network control to become directly programmable and the underlying infrastructure to be abstracted from applications and network services. This means that the SDN architecture is directly programable, agile, centrally managed, and programmatically configured. These features allow for adapting the SDN to changing traffic patterns variations in the amount of data traffic.

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a method for testing a software defined network (SDN) including a plurality of equipment, comprising: selecting a test case, wherein the test case includes a test step to be performed on an equipment of the SDN and wherein the test step includes a template logical indicator and a variable file logical indicator; executing the test case including obtaining at run time a template for the equipment in the SDN to be tested indicated by the template logical indicator, populating at run time variable values in the obtained template using variable values from a variable file indicated by the variable file logical indicator, and executing a first test step indicated in the template using the populated variable values.

Various embodiments are described, wherein the obtained template is one of a plurality of templates, wherein each different equipment type has a related template.

Various embodiments are described, further comprising adding additional template to the plurality of templates when new equipment is added to the SDN.

Various embodiments are described, wherein the variable file is one of a plurality of variable files, wherein each different equipment has a related variable file.

Various embodiments are described, further comprising adding additional variable files to the plurality of variable files when new equipment is added to the SDN.

Various embodiments are described, wherein the executed step may include one of a general-purpose remote procedure calls (GRPC), representational state transfer (REST), REST configuration (RESTCONF) request, TELNET request, secure shell (SSH) request, network configuration (NETCONF) request, and database query.

Various embodiments are described, wherein executing the test case further includes receiving response variable values and executing a second step using the received response variable values

Various embodiments are described, wherein executing the test case further includes receiving response variable values and storing the received response variable values in the variable file.

Further various embodiments relate to a system for testing a software defined network (SDN) including a plurality of equipment, including: a memory; a processor coupled to the memory, wherein the processor is further configured to: select a test case, wherein the test case includes a test step to be performed on an equipment of the SDN and wherein the test step includes a template logical indicator and a variable file logical indicator; execute the test case including obtaining at run time a template for the equipment in the SDN to be tested indicated by the template logical indicator, populating at run time variable values in the obtained template using variable values from a variable file indicated by the variable file logical indicator, and executing a first test step indicated in the template using the populated variable values.

Various embodiments are described, wherein the obtained template is one of a plurality of templates, wherein each different equipment type has a related template.

Various embodiments are described, further comprising adding additional template to the plurality of templates when new equipment is added to the SDN.

Various embodiments are described, wherein the variable file is one of a plurality of variable files, wherein each different equipment has a related variable file.

Various embodiments are described, further comprising adding additional variable files to the plurality of variable files when new equipment is added to the SDN.

Various embodiments are described, wherein the executed step may include one of a general-purpose remote procedure calls (GRPC), representational state transfer (REST), REST configuration (RESTCONF) request, TELNET request, secure shell (SSH) request, network configuration (NETCONF) request, and database query.

Various embodiments are described, wherein executing the test case further includes receiving response variable values and executing a second step using the received response variable values

Various embodiments are described, wherein executing the test case further includes receiving response variable values and storing the received response variable values in the variable file.

Further various embodiments relate to a method for generating test cases for testing a software defined network (SDN) including a plurality of equipment, including: determining the test steps to be implemented by first test case; developing a plurality of templates to carry out each action in the test steps, wherein each action includes a subset of the plurality of templates and each template in the subset is associated with a different equipment type; specifying for each action a template logical indicator that specifies which of the plurality of templates to use at run time based upon the equipment to be tested; developing a plurality of variable files to populate the plurality of templates, wherein each variable file is associated with one of the network equipment; specifying for each action a variable file logical indicator that specifies which of the plurality of variable files to use at run time; producing a computer readable file specifying the first test case including its test steps, template logical indicator, and variable file indicator.

Various embodiments are described, further comprising adding an additional template to the plurality of templates when a new node is added to the SDN.

Various embodiments are described, further comprising adding additional variable files to the plurality of variable files when a new node is added to the SDN.

Various embodiments are described, further comprising generating a second test case wherein the second test case re-uses one of templates and variable files from the first test case.

### BRIEF DESCRIPTION OF THE DRAWINGS

In order to better understand various exemplary embodiments, reference is made to the accompanying drawings, wherein:

FIG. 1 illustrates a test system for testing network devices;

FIG. 2 illustrates a diagram of a first example of a test case;

FIG. 3 illustrates a diagram of a second example of a test case; and

FIG. 4 illustrates an exemplary hardware diagram 400 for the test case system

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Because software defined networks (SDN) are very flexible, a wide variety of different network elements and network features and services may be implemented in the SDN. The introduction of model driven mediation into the SDN controller allows for the run-time replacement and addition of new components to the SDN. These components are intended to provide support for additional network element types, or network element software versions, which could themselves then be divided into customer specific implementations as well. The use of models allows each component to define itself, for example using the Yet Another Next Generation (YANG) format.

The potential number of these types and versions is very high and increasing. It is not efficient nor cost-effective to provide verification of these components in the SDN on an individual basis each time. The time to verify these new element types or re-verify a new software version can become time consuming and expensive. The additional difficulty is that in order to produce software for various new element types, it is generally accepted that access to such a machine is necessary. The cost to purchase different variants and versions of every machine is prohibitive. A solution is to use a generic test-head which could be installed and connected to a customer network, where the specific machine type and version is present. Alternatively, a container with a virtual machine (VM) that implements the testing system could be installed on an available server in the SDN to provide the testing capability. These would allow for the full suite of tests to be run against that new machine.

Embodiments of a system and method using generic test cases for testing an SDN is described herein. The testing method and system may be used for any system and elements in that system, including data flowing through a network system or to web applications or databases, by use of generic templates. The testing method and system isolates the specific content from the generic test case flow in order to allow for simple integration of new components into the testing later on. The same test case is written once and can be re-used over and over to perform the same test flow on any product which supports those same protocols and actions, whether existing or to be developed in the future.

The test system includes the creation of generic test cases where each test case allows for its execution to be controlled via the definition of the test steps, where the test steps are based upon the generic system elements to be tested and parameters related to the generic system element. The test steps may contain actions such as Get an object, Check an object, configure an object, delete an object and so on—in any order or in multiples thereof. Once written, this test case becomes a re-usable test flow in various SDNs with different network elements.

The actual test case procedure is executed by calling generic templates where the content of the templates are populated at run-time by the element definition and variable values. Existing tests may be run against new element types by simply selecting the applicable tests and defining the element specific content, i.e., the templates and the values, to populate the template correctly.

The additional benefit of this testing system and method is that the tests may be executed on any network configuration, as the network definition is to be populated at run time to tailor the test to the specific SDN and elements. The intention is for the tests to be purely generic, based only on the application module or protocol type. For example, in the generic test case if certain steps do not apply to a specific node, those steps may be skipped.

Test case re-use is one of the advantages of the testing system and method. The test-head infrastructure with its generic functions may be extended to use on any system which supports the protocols implemented in the test. For example, such protocols may include general-purpose remote procedure calls (GRPC), representational state transfer (REST), REST configuration (RESTCONF), TELNET, secure shell (SSH), network configuration (NETCONF), and PostGres Standardized Query Language (PGSQL). Test steps to query data and verify the response can be written for any of these in any order, forming the test case. Every test case is written completely generically, and every template may be completely generic to its YANG, DataBase Table, or API definition.

The system will automatically select the correct version of template and test contents to use based on the network definition (which describes the execution elements, which versions are under test, their connections etc.). For example, if the node under test is version 1.4, but template are available for versions 1.0, 1.1, and 1.2, the test will roll back to the test for version 1.2. In this way templates are only updated for new versions as needed. The same suite is used to test multiple software versions, network element types, by simply changing the network definition

A more detailed definition of the test case will now be described. A test case is defined as a list of test steps. Each test step has a desired action, but is generic in that it defined by a set of templates. These template files may be used in multiple test cases. A template file may be created for the desired action or existing templates could also be re-used. A machine specific version of the template file is created for the test case, at run-time with values for each variable in the templates. These values files are stored alongside values files for other testcase that the specific machine/version supports. During execution, the test system will read the template files and populate them with the values from the values file specific to that test case and the machine which is under test. It will then perform the actions specified in the test-step before moving onto the next test step. The system under test and location of the templates and values files are defined generically, by way of logical indicators used in the test-step, which are resolved from the network definition. In this way, the generic logical indicator in the test-case is translated into an actual location of the templates and values files for that execution. The association between the test case, template, and values is derived from the logical indicators in the test case and test steps. The specific machine values may be stored in memory for the duration of the test case and used through each test step, ensuring that the data sent and responses received have data consistency throughout the test case. In this way, the same test case may be used on any other machine that supports that same action, simply by providing the relevant values for the test case and specifying the relative location of the files associated with the logical indicators to be read at run time. Different network definitions will allow for multiple executions of the exact same test cases for different machines, software versions, etc.

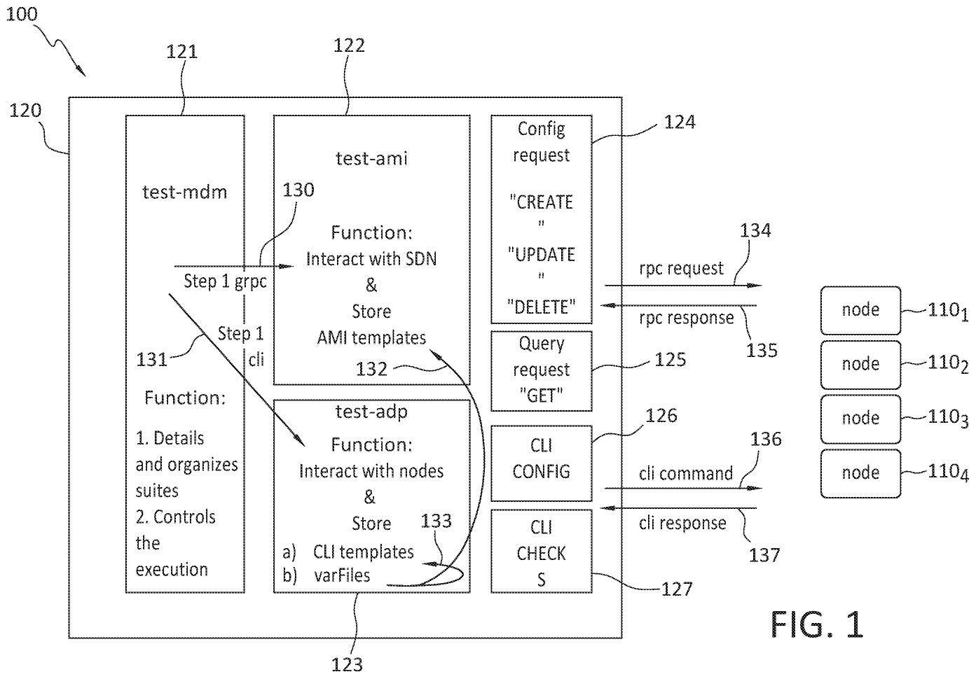

FIG. 1 illustrates a test system for testing network devices. The SDN 100 includes a test controller 120 and network nodes 110₁-110₄. Typical SDNs 100 will have many more nodes. The SDN may also include one more SDN controllers. The SDN controller may be a part of the test controller 120 or may be distributed throughout the network on network nodes. The test controller 120 implements the test capability on the SDN. The test controller 120 may include data depositories test-mdm 121, test-ami 122, and test-adp 123. Further, the test controller 120 may implement a configuration request function 124, query request function 125, command line interface (CLI) configuration function 126, and CLI check function 127.

The test-mdm 121 repository may store the test cases. Also test-mdm 121 stores the test system software code that will execute the testcases, controlling the flow and execution of the test cases. The test-mdm 121 contains the details of the test cases, organizes the test cases, and may also control the execution of the test cases. The test case steps are defined in test-mdm 121. Further, the test cases may be bundled into test suites that may be run on a specified SDN. The test cases are completely generic and may be run on any network element from any vendor with any software version. Further, the templates are completely generic and are only logically associated to the test case. The test-ami repository interacts with the test-mdm 121 and also stores the templates files. These template files define functions that may be carried out for various desired actions. The test-adp 123 repository may interact with the nodes 110₁-110₄ and may store CLI templates and variable values files containing variable values and these values will be machine specific values. The variable values may be supplied to 132, 133 by the test-adp 123 at run time. Also, the variable values specific to each node may be added to or updated with run time data from that node during the execution and used later in a test case. The operation of the test controller 120 will be described below with pseudo-code examples of a test case and a template as well as test case diagrams.

The steps of a test case execute one at a time, in the order specified, against each node. Test cases may be as simple as one or two steps or as complex as desired, can focus solely on GRPC/CLI, or can include Web Application and database requests as well. The test system is capable of testing generically, fully across the SDN within one test case. The same test case and logical templates references may be used for each node in the network definition. Also a test case could be defined to carry out different steps on different nodes as defined by the designer of the test case. Once a test case is written with templates, the only additional work needed to support a new node is to add the node specific values required for that new node/version or type and if need be a template to carry out certain node specific actions or steps such as CLI templates.

The following is a description of the execution of a test case. First, the test case ‘definition’ is read, and then one test step at a time is carried out. The type of action request is noted (e.g., get, create, modify, delete etc.) Next, the type of action may be noted (e.g., GRPC, REST, SQL, CLI, etc.) Any template logical indicator reference in that step action is then used to ‘lookup’ in a network Definition. (e.g., ‘Equipment’) so that the template logical indicator may be translated into a specific location at run time. The specific location and version of that ‘Equipment’ definition is then used to find the actual templates specific to that execution of the test step. Next, the variable values file logical reference of the node for that test step is read and used to ‘lookup’ in the network Definition for the node being tested (e.g., ‘Equipment’) and will be translated into a specific location and version of the variable data for the node at run time. At the same time, the system may look to see if this test case is supported for that node. If it is not, then the remainder of its execution will be skipped and the process will move to the next node or next test step. The location and version of that ‘Equipment’ definition may then be used to find the actual variables and values stored specific to that test case and for that node. The variable values are populated into the template and sent to the SDN using the type of step and type of call specified by the test step. Next, the response from the SDN is received and parsed. As specified in the test step, values from the response may be extracted and stored for later use in the test case. These received values are assigned to a variable as defined in the test step and along with the other variables may be used to either replace existing variable values or create new ones.

Then, the next portion of the test step will then proceed—which may be, for example, a CLI check. The same variable values may be reused. At the end of each test step, the entire process may be repeated for the next node in the network definition. Once the test step has been executed on each node that supports the test step, execution moves to the second test step defined in the test case and the process repeats starting with the noting of the type of action request. Alternatively, all of the test steps may be performed on a node, and then the next node is selected for application of the test steps in the test case. During subsequent test steps, the test case designer may decide if that step requires the use of variables that were read in from a previous step. If so, the test case designer may either create a new variable or overwrite the value of an existing one, for that test step. This is regardless of what type of action it is, be it GRPC, REST, SQL, cli etc. The above actions are repeated for each test step until the end of the test case is reached. As described above, test cases may be bundled into test suites and run sequentially by creating test suites with lists of test cases to be performed as part of the test suite. For such a test suite, after the first test case completes, the second test case will then be executed and so on. A different network definition file may be created describing a totally different set of nodes in an SDN, software versions, versions, etc., and then the same test suite may be executed on that network using the exact same test cases and test steps.

The following pseudo-code provides an example of a test case called GetPort_Test1 and how it could be implemented in software code.

{
″GetPort_1″: {

″grpc″: {

″grpcOperation″: ″query″,
″grpcCall″: ″get″,
″amiType″: ″Equipment″,
″class″: ″sdn-equipment:/equipment/network-elements/network-element″,
″amiTemplateName″: ″GetPort″,
″amiTemplateCheckName″: “../GETPORT_TEST1/GetPortCheck″

},
″adp″: {

″adpType″: ″Equipment″
″adpTemplateName″: ″GetPort.cli″

}

}
},
{
Step 2...
}

The test GetPort_Test1 includes a first step GetPort_1. The step GetPort_1 performs two functions. The first function is a GRPC get query which will query the equipment portion information using the GRPC protocol and check the response. It sends a GRPC request to ‘get’ the port data for each ‘node’ (machine) as defined in the network configuration file. It uses the ‘GetPort’ template. In the pseudo-code, this first function begins by the test-mdm 121 determining that a first grpc function is to be carried out as a part of GetPort_Test1. The code specifies the grpcOperaton as a “query” and the grpcCall as a “get.” The amiType is specified as “Equipment” which includes information regarding the specific structure of the SDN, including the various equipment in the SDN. Further, class specifies the class necessary for the GPRC request with a value of “sdn-equipment:/equipment/network-elements/network-element.” The test step requires the values specified by “Equipment” in the adp section. The specifics of which will be determined at run time from a variable values file stored in test-adp 123. “Equipment” in the adp section is a variable values file logical indicator. Next, a template amiTemplateName, which specifies the template file logical indicator to use for the function, is specified as “GetPort.” This template may be stored in test-ami 122 as shown in FIG. 1. Each of these logical indicators are resolved from the network definition at run time to specify specific template file locations and variable values file locations. For example, the file GetPort may be stored in a GETPORT_TEST1 folder in the Equipment section of the test-ami 122. GetPort itself is not an actual location, but rather the template logical indicator of the location of the template that will be determined at run time of the test case and that will be tailored to the specific network being tested. Further, a template amiTemplateCheckName is specified and provided a value “. . . /GETPORT_TEST1/GetPortCheck.” In FIG. 1, the test-mdm 121 accesses the specific templates 130 from the test-ami 122, as resolved from the network definition. In this case the templates specify that a “get” query request 125 is made, and the rpc request 134 is sent for a node specified in the test step and/or the template. A rpc response 135 is received back and checked using the contents defined in the template as defined by the logical indicator amiTemplateCheckName, which again has been resolved into a specific template at run time. The output of the function may be that this specific test step passed or failed. It might also include receiving information from the node that then is stored back into the variable values to provide information previously not known about the node. For example, port numbers, operating state, or configuration information may be updated and stored in the variable values.

The test case GetPort_Test1 also includes a second function, adp, that uses a CLI template to initiate command and response to further check that get request was done properly on the node. The adp function first specifies the adpType as “Equipment” which is the logical indicator for each node and defined for each node in the network definition, that supports such. Next, a template adpTemplateName is specified as “GetPort.cli.” As before this provides a specific definition for this function for the specific network element and is the template logical indicator for the location of the template file that is used at run time. This is shown in FIG. 1, where the test-mdm 121 gets the template 131 from the test-adp 123. The test-adp 123 also stores the variable values files having the data to be used to populate the template adpTemplateName with values specific to the node or nodes to be tested. Next, the CLI check function 127 may be called and used to log into the node or nodes 110₁ to 110₄ and execute the commands specified in the template and receive the response back 137 and check the response 127. As before, this may indicate whether the test fails or passes as well as collecting information from the node to be stored for future use or reference.

At run time, a network definition file is read, for example to find the specifics as indicated by the variable file logical indicator Equipment, will associate the nodes (machines) to the generic labels of the test cases. Each folder in test-adp will contain the same structure as for the other machines, but the contents will vary depending on the specifics of the machine. Template and value variable values files re-use is intended to minimize test execution maintenance. Templates are not expected to be changed often, but when they do change new versions can be specified and new node details are added as variable values files located in test-adp as new types of nodes and software are implemented in the SDN.

The following pseudo-code provide an example of a template GetPortCheck that might be used in the grpc function of the above pseudo-code.

{

“port-name” : “{{portId}}”,
“mode” : “{{portMode}}”,
“max-speed” : “{{maxSpeed}}”,
“actual-speed” : “{{actualSpeed}}”,
“encap-type” : “{{portEncap}}”,
“port-class” : “{{portClass}}”,
“port-category” : “{{portCategory}}”,
“capabilities” : {

“capability” : “{{portCapability}}”,
“_classId_” : “sdn-equipment:/equipment/ports/port/capabilities”

},
“_classId_” : “sdn-equipment:/equipment/ports/port”

}

This template shows a variety of different attributes and their associated variable values. The values may be specifically specified or may be obtained from an associated variable file, or obtained at run-time. The various attributes help define the specifics of the function to be carried out by this template. Such a template may be stored for example in test-ami 122.

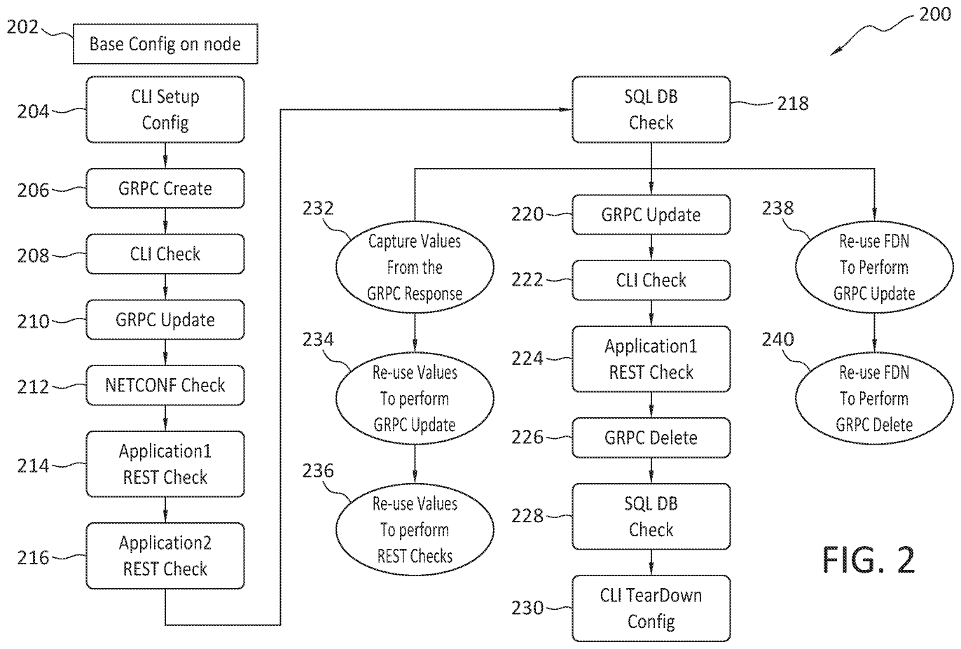

FIG. 2 illustrates a diagram of a first example of a test case 200. The nodes have a base configuration 202. This will include the type of equipment, installed software and services, and various other configuration paraments. The first step 204 performs a CLI setup configuration by logging into the node using TELNET and issuing CLI commands to make changes to the node's configuration. Next, the test case includes a GRPC create 206 and a CLI check 208. The GRPC create 206 may create something on the system, such as some sort of service. At this point, values 232 related to the node may be captured for use elsewhere during the test case. The CLI check 208 may check that the create was correctly carried out as requested by the GRPC create 206. For example, was a requested service set up on the node. The next test step may include an GRPC update 210 and a NETCONF Check 212. The GRPC update 210 may update for example the service created or some other aspect of the node. This action may reuse the values 234 so that the test case updates the exact same service previously created. The NETCONF check 212 may be used to check the GRPC update 210. In this case a NETCONF check is used to show that different sorts of CLI type of connections may be used. Next, an Application1 REST request check 214 may be sent to do check on a first application. Again the prior values 236 may be used in this step. An Application2 REST check 216 may next be performed to check a second application. A SQL database check 218 may be done by querying the database to verify that values queried in the database are correct, and again the same variable values 238 are used as before. Then a GRPC update 220, a CLI check 222, and an Application1 REST check 224 may be performed as before. The next step may include a GRPC delete 226 and a SQL Database Check 228. The GRPC delete 226 may be used to delete the service using the same values 240 as before. The SQL database check 228 may be performed to verify that the service has been deleted from the node. Finally, a CLI TearDown Config step 230 may be performed to remove the CLI configuration and to return the node back to its starting configuration.

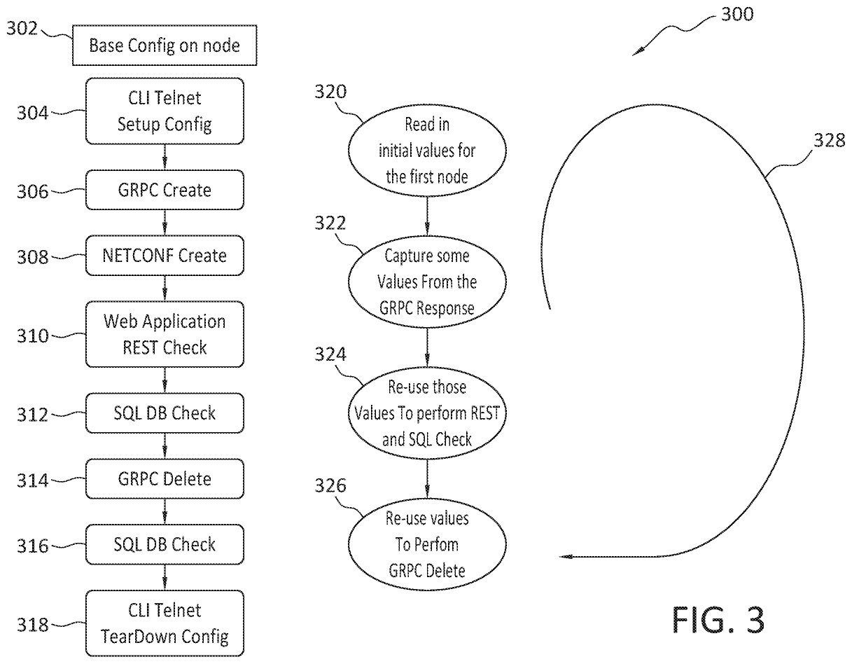

FIG. 3 illustrates a diagram of a second example of a test case 300. The nodes have a base configuration 302. This will include the type of equipment, installed software and services, and various other configuration paraments. The first step 304 performs a CLI setup configuration by logging into the node using TELNET and issuing CLI commands to make changes to the nodes configuration. At this point, values 320 related to the node may be captured for use elsewhere during the test case. Next, the test case includes a GRPC create 306 and a NETCONF check 308. The GRPC create 306 may create something on the system, such as some sort of Web Application Policy. The NETCONF check 308 may check that the create was correctly carried out as requested by the GRPC create 306. For example, was a requested Web Application Policy set up on the node. This step may reuse the values 322 previously obtained by the test case. The next test step may include an Web Application REST Check 310 and a SQL database Check 312. The Web Application REST Check 310 may use the REST protocol to check a web application policy details on the node. This action may reuse the values 324 so that the test case updates check the correct Web Application Policy. The SQL database check 312 may be done by querying the database to verify that values queried in the database are correct. Next, a step including a GRPC delete 314 and SQL database check 316 may be performed. The GRPC delete 314 may be used to delete the Web Application Policy using the same values 326 as before. The SQL database check 316 may be performed to verify that the Web Application Policy has been deleted. Finally, a CLI TELNET TearDown Config step 318 may be performed to remove the CLI configuration and to return the node back to its starting configuration. Then as indicated by arrow 328, this process may be repeated for each node in the network definition that supports the test case.

The embodiments of the test system and methods described herein may be implemented in various ways. A hardware test head may be connected to a SDN to be tested. The hardware test head would include software that includes the test cases, templates, and variable files needed to test the SDN. A user could then initiate the various test cases or test suites of interested on the specific SDN, that the cases would at run time use the templates and variable files needed for the specific nodes and network elements to be tested. In another embodiment, a container implemented in a virtual machine may be developed that allows the test software to run in a virtual machine installed on an available server in the SDN to be tested. Again the user could run the desired tests, from within the container, on the SDN.

The test cases may be selected and run by a user, or may be run automatically based upon a user specified schedule. In other situations, as certain events occur in the SDN, test cases may be run in response.

A test case designer may create test cases. First, the designer may determine the test steps to be implemented by the test case. Next, the designer may develop a plurality of templates to carry out each action in the test steps. For each action, templates may be produced for each component of the system. In some cases, a template may be applicable across different types of systems. Next, the designer may specify for each action a template logical indicator that specifies which of the plurality of templates to use at run time based upon the network definition to be tested. Next, the designer may develop a plurality of variable files for each of the network equipment. This may include a specific file structure that then is populated with data for each node. As each network equipment is unique, each will typically have its own specific variable values files. The designer then may specify for each action a variable file logical indicator that specifies which of the plurality of variable files to use at run time. Finally, the designer may produce a computer readable file specifying the first test case including its test steps, template logical indicator, and variable file indicator.

As new equipment is to be tested on SDNs, the necessary templates and variable files for that equipment may be added to the test system, and the same generical test cases may be run using the logical template and variable files for the new equipment. This provides a technological advancement in the testing of complex SDNs because the test cases can be developed to run specific types of tests across the SDN or across different SDNs independent of the very specific details and parameters of the specific network nodes and equipment. Those details may be provided at run time via the equipment/node specific templates and variable files. Further, the use of logical indicators to the templates and variable files allows for the test cases to be applicable across a wide range of SDNs and equipment types because the specific details needed for the test case are provided at run time as specified by the logical indicators. This allows for increased portability of the test cases across SDNs to be tested. For each SDN to be tested, the logical indicators will be defined in order to access and carry out the needed test cases. This flexible testing architecture means that test cases may be developed that are independent of the specific details of the equipment making up an SDN, because obtaining each type of equipment and then developing specific test cases becomes expensive and unfeasible as the number of different types of network equipment varies. This is further compounded by the fact that various software versions may be available for the equipment, and each of these different versions of the software would need be able to be tested. Additionally, the templates may be re-used across various test cases to further streamline the development of new test cases, being populated with variable values relevant to that test case.

While the test system disclosed herein has been described in the context of SDNs, the template based testing approach may be used in other types of systems that require testing and that might have many different types of components.

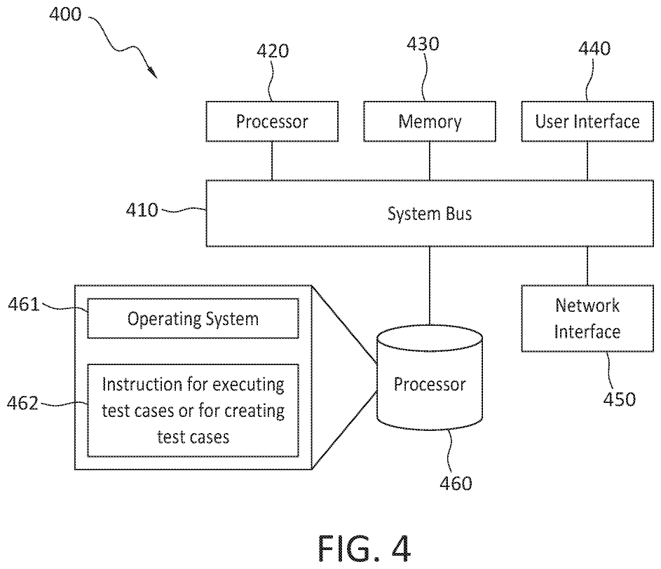

FIG. 4 illustrates an exemplary hardware diagram the test controller described in FIG. 1 which may perform the test cases described in FIGS. 2 and 3. As shown, the device 400 includes a processor 420, memory 430, user interface 440, network interface 450, and storage 460 interconnected via one or more system buses 410. It will be understood that FIG. 4 constitutes, in some respects, an abstraction and that the actual organization of the components of the device 400 may be more complex than illustrated.

The processor 420 may be any hardware device capable of executing instructions stored in memory 430 or storage 460 or otherwise processing data. As such, the processor may include a microprocessor, a graphics processing unit (GPU), field programmable gate array (FPGA), application-specific integrated circuit (ASIC), any processor capable of parallel computing, or other similar devices. The processor may also be a special processor that implements machine learning models.

The memory 430 may include various memories such as, for example L1, L2, or L3 cache or system memory. As such, the memory 430 may include static random-access memory (SRAM), dynamic RAM (DRAM), flash memory, read only memory (ROM), or other similar memory devices.

The user interface 440 may include one or more devices for enabling communication with a user and may present information to users. For example, the user interface 440 may include a display, a touch interface, a mouse, and/or a keyboard for receiving user commands. In some embodiments, the user interface 440 may include a command line interface or graphical user interface that may be presented to a remote terminal via the network interface 450. This user interface 440 may be used by a user to select and run test cases on the SDN.

The network interface 450 may include one or more devices for enabling communication with other hardware devices. For example, the network interface 450 may include a network interface card (NIC) configured to communicate according to the Ethernet protocol or other communications protocols, including wireless protocols. Additionally, the network interface 450 may implement a TCP/IP stack for communication according to the TCP/IP protocols. Various alternative or additional hardware or configurations for the network interface 450 will be apparent.

The storage 460 may include one or more machine-readable storage media such as read-only memory (ROM), random-access memory (RAM), magnetic disk storage media, optical storage media, flash-memory devices, or similar storage media. In various embodiments, the storage 460 may store instructions for execution by the processor 420 or data upon which the processor 420 may operate. For example, the storage 460 may store a base operating system 461 for controlling various basic operations of the hardware 400. The storage 462 may store instructions for carrying out the test cases or creating test cases.

It will be apparent that various information described as stored in the storage 460 may be additionally or alternatively stored in the memory 430. In this respect, the memory 430 may also be considered to constitute a “storage device” and the storage 460 may be considered a “memory.” Various other arrangements will be apparent. Further, the memory 430 and storage 460 may both be considered to be “non-transitory machine-readable media.” As used herein, the term “non-transitory” will be understood to exclude transitory signals but to include all forms of storage, including both volatile and non-volatile memories.

While the system 400 is shown as including one of each described component, the various components may be duplicated in various embodiments. For example, the processor 420 may include multiple microprocessors that are configured to independently execute the methods described herein or are configured to perform steps or subroutines of the methods described herein such that the multiple processors cooperate to achieve the functionality described herein. Such plurality of processors may be of the same or different types. Further, where the device 400 is implemented in a cloud computing system, the various hardware components may belong to separate physical systems. For example, the processor 420 may include a first processor in a first server and a second processor in a second server.

Any combination of specific software running on a processor to implement the embodiments of the invention, constitute a specific dedicated machine.

As used herein, the term “non-transitory machine-readable storage medium” will be understood to exclude a transitory propagation signal but to include all forms of volatile and non-volatile memory.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for testing a software defined network (SDN) including a plurality of equipment, comprising:
selecting a test case, wherein the test case includes a test step to be performed on an equipment of the SDN and wherein the test step includes a template logical indicator and a variable file logical indicator;
executing the test case including
obtaining at run time a template for the equipment in the SDN to be tested indicated by the template logical indicator,
populating at run time variable values in the obtained template using variable values from a variable file indicated by the variable file logical indicator, and
executing a first test step indicated in the template using the populated variable values.

2. The method of claim 1, wherein the obtained template is one of a plurality of templates, wherein each different equipment type has a related template.

3. The method of claim 2, further comprising adding additional template to the plurality of templates when new equipment is added to the SDN.

4. The method of claim 1, wherein the variable file is one of a plurality of variable files, wherein each different equipment has a related variable file.

5. The method of claim 4, further comprising adding additional variable files to the plurality of variable files when new equipment is added to the SDN.

6. The method of claim 1, wherein the executed step may include one of a general-purpose remote procedure calls (GRPC), representational state transfer (REST), REST configuration (RESTCONF) request, TELNET request, secure shell (SSH) request, network configuration (NETCONF) request, and database query.

7. The method of claim 1, wherein executing the test case further includes receiving response variable values and executing a second step using the received response variable values

8. The method of claim 1, wherein executing the test case further includes receiving response variable values and storing the received response variable values in the variable file.

9. A system for testing a software defined network (SDN) including a plurality of equipment, comprising:
a memory;
a processor coupled to the memory, wherein the processor is further configured to:
select a test case, wherein the test case includes a test step to be performed on an equipment of the SDN and wherein the test step includes a template logical indicator and a variable file logical indicator;
execute the test case including
obtaining at run time a template for the equipment in the SDN to be tested indicated by the template logical indicator,
populating at run time variable values in the obtained template using variable values from a variable file indicated by the variable file logical indicator, and
executing a first test step indicated in the template using the populated variable values.

10. The system of claim 9, wherein the obtained template is one of a plurality of templates, wherein each different equipment type has a related template.

11. The system of claim 10, further comprising adding additional template to the plurality of templates when new equipment is added to the SDN.

12. The system of claim 9, wherein the variable file is one of a plurality of variable files, wherein each different equipment has a related variable file.

13. The system of claim 12, further comprising adding additional variable files to the plurality of variable files when new equipment is added to the SDN.

14. The system of claim 9, wherein the executed step may include one of a general-purpose remote procedure calls (GRPC), representational state transfer (REST), REST configuration (RESTCONF) request, TELNET request, secure shell (SSH) request, network configuration (NETCONF) request, and database query.

15. The system of claim 9, wherein executing the test case further includes receiving response variable values and executing a second step using the received response variable values

16. The system of claim 9, wherein executing the test case further includes receiving response variable values and storing the received response variable values in the variable file.

17. A method for generating test cases for testing a software defined network (SDN) including a plurality of equipment, comprising:
determining the test steps to be implemented by first test case;
developing a plurality of templates to carry out each action in the test steps, wherein each action includes a subset of the plurality of templates and each template in the subset is associated with a different equipment type;
specifying for each action a template logical indicator that specifies which of the plurality of templates to use at run time based upon the equipment to be tested;
developing a plurality of variable files to populate the plurality of templates, wherein each variable file is associated with one of the network equipment;
specifying for each action a variable file logical indicator that specifies which of the plurality of variable files to use at run time;
producing a computer readable file specifying the first test case including its test steps, template logical indicator, and variable file indicator.

18. The method of claim 17, further comprising adding an additional template to the plurality of templates when a new node is added to the SDN.

19. The method of claim 1, further comprising adding additional variable files to the plurality of variable files when a new node is added to the SDN.

20. The method of claim 1, further comprising generating a second test case wherein the second test case re-uses one of templates and variable files from the first test case.
